(19) United States
(12) Patent Application Publication
(10) Pub. No.: US 2025/0007092 A1
(43) Pub. Date: Jan. 2, 2025

(54) PRESSURE EQUALIZATION DEVICE FOR TRACTION BATTERY PACK

(71) Applicant: Ford Global Technologies, LLC, Dearborn, MI (US)

(72) Inventors: Alexander Robert Rink, Royal Oak, MI (US); Mariah Jane Seybold, Royal Oak, MI (US); Parikshit S. Gupte, West Bloomfield, MI (US); Xiaogang Zhang, Novi, MI (US)

(21) Appl. No.: 18/346,215

(22) Filed: Jul. 1, 2023

(51) Int. Cl. H01M 50/30; B60L 50/64; H01M 50/204; H01M 50/308; H01M 50/317

(52) U.S. Cl. CPC H01M 50/394; B60L 50/64; H01M 50/204; H01M 50/308; H01M 50/317; H01M 2200/10; H01M 2200/20; H01M 2220/20

(57) ABSTRACT

A traction battery pack includes an enclosure assembly; and a pressure equalization device received within a wall of the enclosure assembly. The pressure equalization device includes a housing assembly and a flow restrictor configured to restrict flow through the housing assembly during a battery thermal event of the traction battery pack.

### TECHNICAL FIELD

This disclosure relates generally to electrified vehicle traction battery packs and, more particularly, to pressure equalization devices for traction battery packs.

### BACKGROUND

A high-voltage traction battery pack typically powers an electric machine and other electrical loads of an electrified vehicle. The traction battery pack includes a plurality of battery cells and various other battery internal components that are housed inside an enclosure assembly for supporting the electric propulsion of the vehicle. The enclosure assembly is sealed, but vented to prevent moisture from accumulating within the interior of the battery pack.

### SUMMARY

In some aspects, the techniques described herein relate to a traction battery pack, including: an enclosure assembly; and a pressure equalization device received within a wall of the enclosure assembly, the pressure equalization device includes a housing assembly and a flow restrictor configured to restrict flow through the housing assembly during a battery thermal event of the traction battery pack.

In some aspects, the techniques described herein relate to a traction battery pack, wherein the flow restrictor is a disk having an opening.

In some aspects, the techniques described herein relate to a traction battery pack, wherein the pressure equalization device includes internal bore extending from an inlet to an outlet, the opening having a diameter that is less than a diameter of the internal bore.

In some aspects, the techniques described herein relate to a traction battery pack, wherein the flow restrictor is disposed outside the enclosure assembly.

In some aspects, the techniques described herein relate to a traction battery pack, wherein the flow restrictor is configured to restrict flow though through the pressure equalization device from 78 to 88 percent.

In some aspects, the techniques described herein relate to a traction battery pack, wherein the housing assembly includes an engagement section that interfaces with a wall of the enclosure assembly and an outer section that protrudes outwardly of the wall, the engagement section providing an inlet to the housing assembly, the outer section providing an outlet from the housing assembly, the flow restrictor configured to restrict the flow between the inlet and the outlet.

In some aspects, the techniques described herein relate to a traction battery pack, further including a membrane held within the housing assembly and covering the outlet.

In some aspects, the techniques described herein relate to a traction battery pack, wherein the flow restrictor is configured to restrict flow to be less that an amount of flow that is possible through the outlet covered by the membrane.

In some aspects, the techniques described herein relate to a traction battery pack, wherein the membrane is a water-impermeable membrane held within the housing assembly.

In some aspects, the techniques described herein relate to a traction battery pack, wherein the water-impermeable membrane is configured to allow flow to exit the pressure equalization device.

In some aspects, the techniques described herein relate to a traction battery pack, wherein the flow restrictor is sandwiched between the engagement section and the outer section.

In some aspects, the techniques described herein relate to a traction battery pack, wherein the engagement section is secured to the outer section with a crimp fit.

In some aspects, the techniques described herein relate to a traction battery pack, wherein the engagement section is mounted to the wall with a twist-lock.

In some aspects, the techniques described herein relate to a traction battery pack, wherein the housing assembly is dome-shaped, and further wherein the wall is part of an enclosure tray of the enclosure assembly.

In some aspects, the techniques described herein relate to a traction battery pack, including a plurality of battery arrays housed inside the enclosure assembly.

In some aspects, the techniques described herein relate to a traction battery pack flow control method, including: receiving a first amount of flow at an inlet of a pressure equalization device, the first amount of flow from an interior of a battery pack; restricting the first amount of flow to a second amount of flow that is less than the first amount of flow; and permitting the second amount of flow to move through a outlet of the pressure equalization device.

In some aspects, the techniques described herein relate to a traction battery pack flow control method, wherein outlet is covered by a membrane.

In some aspects, the techniques described herein relate to a traction battery pack flow control method, wherein the restricting occurs by directing the flow through an opening in a flow restrictor.

In some aspects, the techniques described herein relate to a traction battery pack flow control method.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for the electrified vehicle of FIG. 1.

FIG. 3 is a perspective view of another exemplary traction battery pack.

FIG. 4 is a cross-sectional view through section 4-4 of FIG. 2 and illustrates features associated with a pressure equalization device of the traction battery pack according to an exemplary embodiment of the present disclosure.

FIG. 5 illustrates a perspective view of a flow restrictor from the pressure equalization device of FIG. 4.

FIG. 6 illustrates a perspective view of the pressure equalization device of FIG. 4.

FIG. 7 illustrates a section view through a housing assembly and the flow restrictor of the pressure equalization device of FIG. 4.

### DETAILED DESCRIPTION

This disclosure details exemplary traction battery pack designs for use in electrified vehicles. Exemplary traction battery packs can include an enclosure assembly establishing an interior, and a battery array housed within the interior.

To equalize the pressure inside the battery pack during normal battery operations a pressure equalization device can be disposed within a wall of the enclosure assembly. These and other features are discussed in greater detail in the following paragraphs of this detailed description.

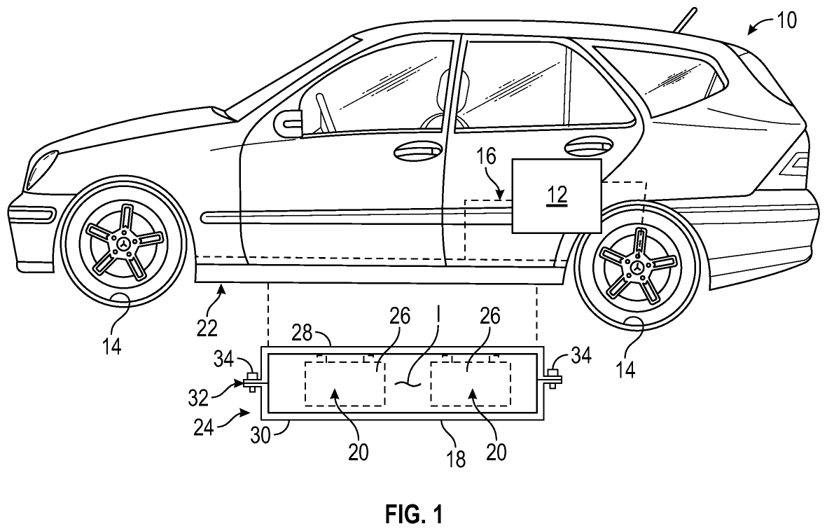

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In the illustrated embodiment, the electrified vehicle 10 is a sport utility vehicle (SUV). However, the electrified vehicle 10 could alternatively be a car, a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10

A voltage bus 16 may electrically couple the electric machine 12 to a traction battery pack 18. The traction battery pack 18 is an exemplary electrified vehicle battery. The traction battery pack 18 may be a high voltage traction battery pack that includes one or more battery arrays 20 (i.e., battery assemblies or groupings of rechargeable battery cells 26) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 26 may be stacked side-by-side along a stack axis to construct a grouping of battery cells 26, sometimes referred to as a “cell stack.” In the highly schematic depiction of FIG. 1, the battery cells 26 are stacked in a direction into the page to construct each battery array 20, and thus the battery arrays 20 extend in cross-car direction. However, other configurations may also be possible.

The total number of battery arrays 20 and battery cells 26 provided within the traction battery pack 18 is not intended to limit this disclosure. In an embodiment, the battery cells 26 of each battery array 20 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The traction battery pack 18 may be secured to an underbody 22 of the electrified vehicle 10. However, the traction battery pack 18 could be located elsewhere on the electrified vehicle 10 within the scope of this disclosure.

An enclosure assembly 24 houses the battery array 20 of the traction battery pack 18. The enclosure assembly 24 can be a sealed enclosure and may embody any size, shape, and configuration within the scope of this disclosure.

In the exemplary embodiment, the enclosure assembly 24 includes an enclosure cover 28 and an enclosure tray 30. Together, the enclosure cover 28 and the enclosure tray 30 may establish an interior I for housing assembly the battery arrays 20 and other battery internal components (e.g., bussed electrical center, battery electric control module, wiring, connectors, etc.) of the traction battery pack 18.

During assembly of the traction battery pack 18, the enclosure cover 28 may be secured to the enclosure tray 30 at an interface 32 therebetween. The interface 32 may substantially circumscribe the interior I. In some implementations, mechanical fasteners 34 may be used to secure the enclosure cover 28 to the enclosure tray 30, although other fastening methodologies (adhesion, etc.) could also be suitable for this purpose.

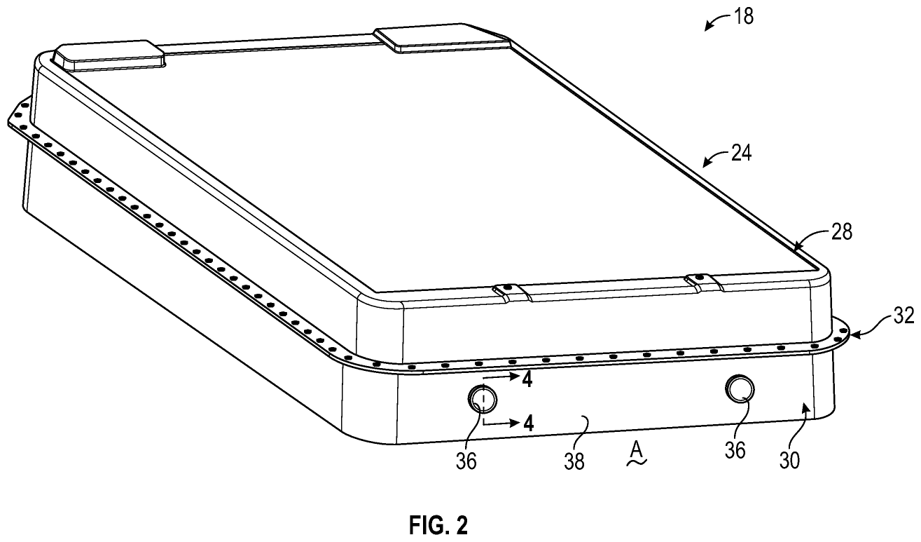

Referring now to FIG. 2, with continued reference to FIG. 1, the traction battery pack 18 may include one or more pressure equalization devices 36. Although two pressure equalization devices 36 are shown, the traction battery pack 18 may include a greater or fewer number of such devices.

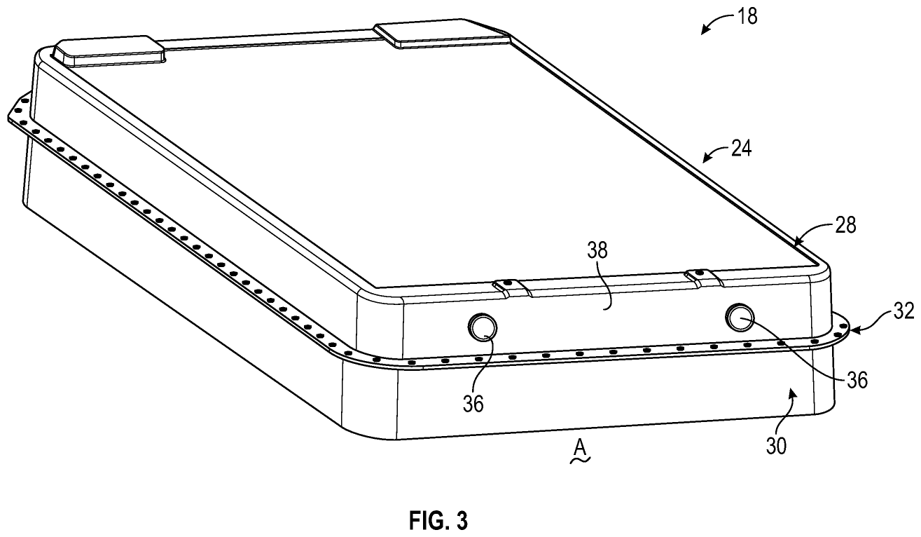

Each pressure equalization device 36 can be disposed within a wall 38 of the enclosure assembly 24. In an embodiment, the wall 38 is part of the enclosure tray 30. In another embodiment, the wall 38 is part of the enclosure cover 28 (see FIG. 3). The precise mounting location of each pressure equalization device 36 could vary and is therefore not intended to limit this disclosure.

The pressure equalization devices 36 can be secured to the wall 38 in any manner. In the example embodiment, each pressure equalization device 36 is secured within the wall 38 via a twist-lock style mount. However, the pressure equalization devices 36 could alternatively or additionally be mounted via mechanical fasteners, cam locks, adhesion, etc.

Each pressure equalization device 36 is be configured to equalize pressure between the interior I of the traction battery pack 18 and an atmosphere A outside of the traction battery pack 18. For example, during normal battery operations, the pressure equalization devices 36 may allow flow (e.g., air) to flow in and out of the enclosure assembly 24 while preventing moisture, particle contaminants, etc. from entering the interior I of the traction battery pack 18.

There may be some operating conditions where pressure and thermal energy within the interior I rapidly increase. For example, battery thermal events may occur during over-temperature, over-charging, or over-discharging conditions of the battery cells 26, or during other battery cell conditions. Battery vent byproducts may be released from one or more battery cells 26 of the battery arrays 20 during these conditions. Permitting a full flow of the vent byproducts through the pressure equalization device 36 can disrupt the integrity of the pressure equalization device 36. This disclosure is therefore directed to pressure equalization devices that are capable of both providing pressure equalization during normal battery operations and a controlled flow of battery vent byproducts through the pressure equalization devices during battery thermal events.

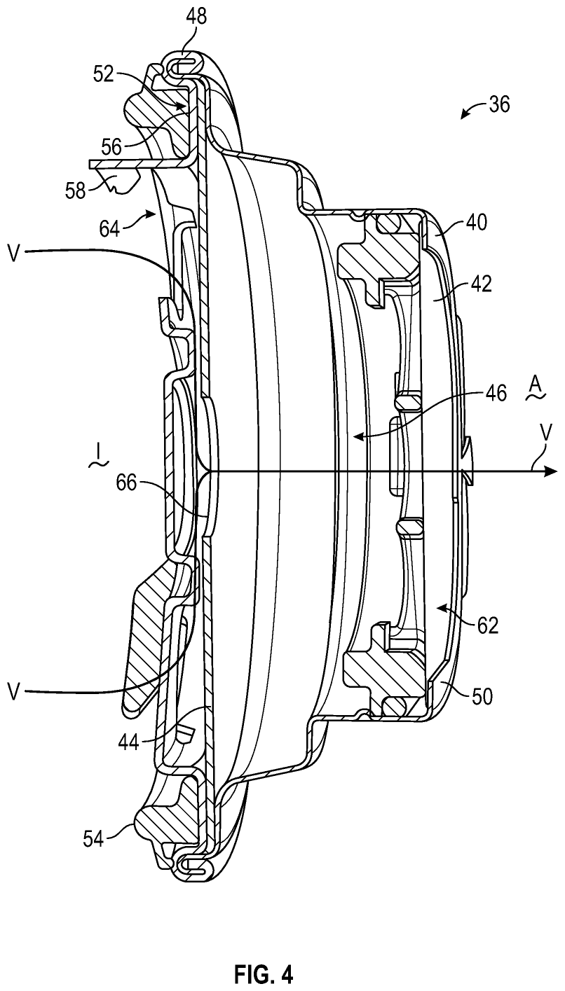

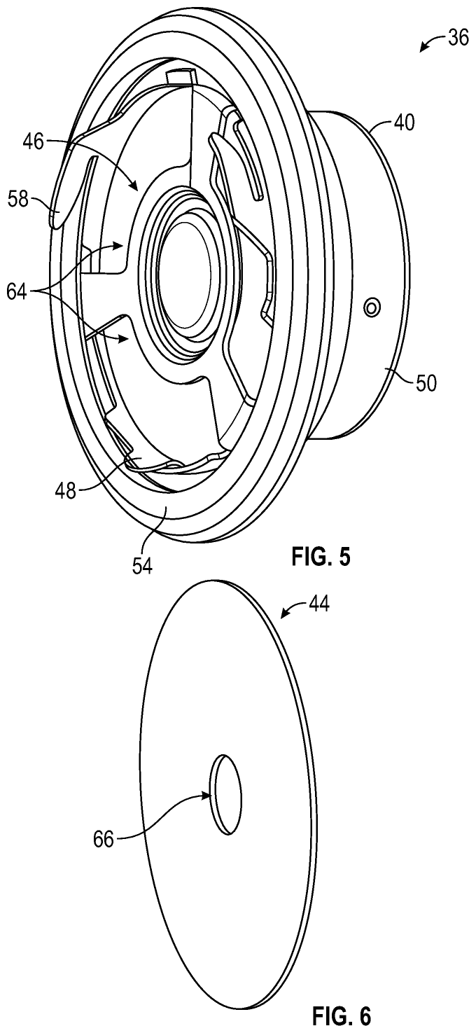

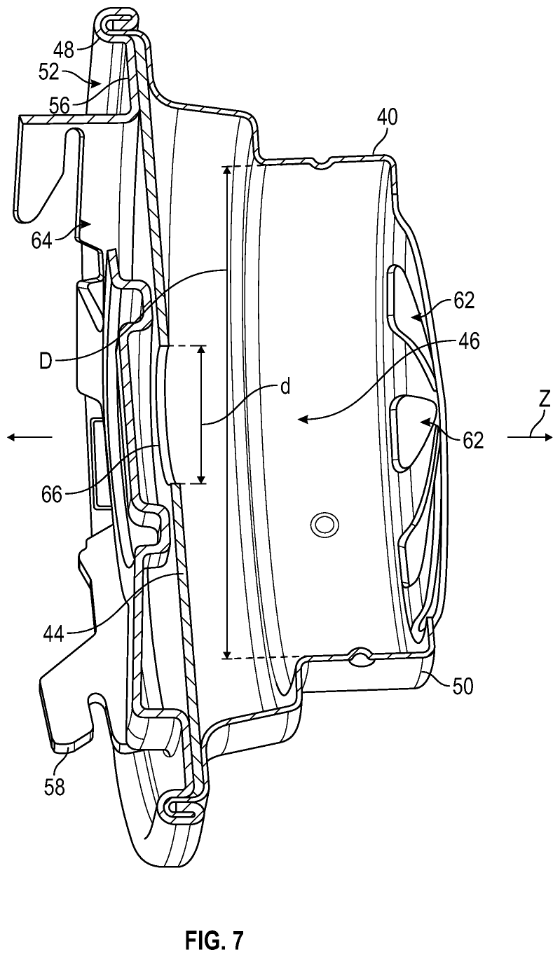

With reference now to FIGS. 4-7 and continuing reference to FIGS. 1-3, the example pressure equalization device 36 includes a housing assembly 40, a water-impermeable membrane 42, and a flow restrictor 44. The housing assembly 40 may include an internal bore 46. The water-impermeable membrane 42 and the flow restrictor 44 are accommodated within different sections of the internal bore 46. The flow restrictor 44 restricts the possible flow through the internal bore 46 of the pressure equalization device 36 relative to an amount flow through the internal bore 46 that would be possible without the flow restrictor 44.

The housing assembly 40 may be a plastic component or a metallic component and may include a single-piece structure or a multi-piece structure. In an embodiment, the housing assembly 40 is dome-shaped. However, the size and shape of the housing assembly 40 is not intended to limit this disclosure.

The example housing assembly 40 is oriented along a central axis Z. The example housing assembly 40 includes an engagement section 48 that interfaces with the wall 38 of the enclosure assembly 24 and an outer section 50 that protrudes outwardly of the wall 38 (see FIG. 2).

A groove 52 is formed on a rear surface 56 of the engagement section 48. A seal 54 is be received within the groove 52. The seal 54 may be configured to seal the interface between the wall 38 of the enclosure assembly 24 and the housing assembly 40 of the pressure equalization device 36. The seal 54 could be a bore seal, an adhesive seal, a press-in-place seal, a carrier gasket, a form in place sealant, or any other suitable sealing device/agent.

The example, engagement section 48 of the housing assembly 40 includes an attachment portion 58, which is circumscribed by the groove 52. The attachment portion 58 include a boss feature that is configured to establish a twist-lock attachment used to secure the housing assembly 40 to the wall 38 of the enclosure assembly 24. When the housing assembly 40 is secured to the wall 38, the flow restrictor 44 of the pressure equalization device is outside the wall 38 of the enclosure assembly 24.

The internal bore 46 opens to atmosphere A at an outlet 62 formed in the outer section 50 of the housing assembly 40. The outlet 62 can be provided by a plurality of individual openings. The internal bore 46 opens to the interior I of the traction battery pack 18 at an inlet 64 provided by a plurality of openings within the engagement section 48. The internal bore 46 extends from the inlet 64 to the outlet 62.

The water-impermeable membrane 42 is held within the outer section 50 of the housing assembly 40. The water-impermeable membrane 42 spans across the outlet 62 such that flow exiting the pressure equalization device 36 through the outlet 62 passes through the water-impermeable membrane 42.

The water-impermeable membrane 42 may be a patch, filter, or some other porous membrane that allow a flow of gases in and out of the enclosure assembly 24 while preventing moisture, particle contaminants, etc. from flowing through the internal bore 46 to the interior I of the traction battery pack 18 during normal battery operations. The water-impermeable membrane 42 therefore provides pressure equalization between the interior I of the traction battery pack 18 and atmosphere A.

The flow restrictor 44 is received within the internal bore 46 at a location between the inlet 64 provided by the attachment portion 58 and the water-impermeable membrane 42. The flow restrictor 44, in this example, is a disk that includes an opening 66, which has a diameter d that is smaller than a smallest diameter D of the internal bore 46.

The flow restrictor 44 is sandwiched between the engagement section 48 of the housing assembly 40 and the outer section 50 of the housing assembly 40. A crimp fit can be used to secure the outer section 50 to the engagement section 48 with the flow restrictor 44 capture therebetween.

Gases received from the interior I of the traction battery pack 18 can enter the pressure equalization device 36 through the inlet 64, flow through the internal bore 46 and through the opening 66 of the flow restrictor 44. The gases that have moved through the opening 66 can exit the pressure equalization device 36 at the outlet 62 while passing through the water-impermeable membrane 42.

During a battery thermal event, battery vent byproducts V that are released by the battery cells 26 can rapidly increase the pressure inside the interior I of the traction battery pack 18. The amount of flow moving through the inlet 64 is correspondingly increased.

The flow restrictor 44 with the opening 66 restrict the flow during the battery thermal event so areas of the pressure equalization device 36, and particularly the water-impermeable membrane 42 are not exposed to all of the flow associated with the battery thermal event. The flow restrictor 44 is configured to restrict flow of the byproducts V to be less that an amount of flow that is possible through the outlet 62 without the flow restrictor 44. In particular, the flow restrictor 44 is configured to restrict flow though through the pressure equalization device from 78 to 88 percent.

The flow restrictor 44 prevents at least some of the battery vent byproducts 70 that are released by battery cells 26 of the traction battery pack 18 during the battery thermal event from exiting from the pressure equalization device 36 through the outlet 62. The battery vent byproducts 70 may therefore be forced to exit the traction battery pack 18 only through separate venting channels as part of a dedicated venting management strategy of the traction battery pack 18. The opening 66 can be sized to permit only an amount of battery vent byproducts 70 that will not disrupt the integrity of the water-impermeable membrane 42.

The pressure equalization device 36 thus receives a first amount of flow at the inlet 64 from the interior I. Within the pressure equalization device 36, the flow restrictor 44 restricts the first amount of flow to permit a second amount of flow that is less than the first amount of flow to move through the outlet 62 of the pressure equalization device 36.

The exemplary traction battery packs of this disclosure incorporate pressure equalization devices that serve the dual function of equalizing pressure inside the traction battery pack during normal battery conditions and throttling a release of battery venting byproducts during battery thermal events. The proposed devices are relatively simple and inexpensive to assemble and manufacture and do not require complex modifications to the battery pack sealing strategy. The flow restrictor 44 can protect, among other things, the water-impermeable membrane 42 without needing to incorporate a relatively complex flow-shut off mechanism into the pressure equalization device 36.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly; and
a pressure equalization device received within a wall of the enclosure assembly, the pressure equalization device includes a housing assembly and a flow restrictor configured to restrict flow through the housing assembly during a battery thermal event of the traction battery pack.

2. The traction battery pack of claim 1, wherein the flow restrictor is a disk having an opening.

3. The traction battery pack of claim 2, wherein the pressure equalization device includes internal bore extending from an inlet to an outlet, the opening having a diameter that is less than a diameter of the internal bore.

4. The traction battery pack of claim 1, wherein the flow restrictor is disposed outside the enclosure assembly.

5. The traction battery pack of claim 1, wherein the flow restrictor is configured to restrict flow though through the pressure equalization device from 78 to 88 percent.

6. The traction battery pack of claim 1, wherein the housing assembly includes an engagement section that interfaces with a wall of the enclosure assembly and an outer section that protrudes outwardly of the wall, the engagement section providing an inlet to the housing assembly, the outer section providing an outlet from the housing assembly, the flow restrictor configured to restrict the flow between the inlet and the outlet.

7. The traction battery pack of claim 6, further comprising a membrane held within the housing assembly and covering the outlet.

8. The traction battery pack of claim 7, wherein the flow restrictor is configured to restrict flow to be less that an amount of flow that is possible through the outlet covered by the membrane.

9. The traction battery pack of claim 7, wherein the membrane is a water-impermeable membrane held within the housing assembly.

10. The traction battery pack of claim 9, wherein the water-impermeable membrane is configured to allow flow to exit the pressure equalization device.

11. The traction battery pack of claim 6, wherein the flow restrictor is sandwiched between the engagement section and the outer section.

12. The traction battery pack of claim 11, wherein the engagement section is secured to the outer section with a crimp fit.

13. The traction battery pack of claim 11, wherein the engagement section is mounted to the wall with a twist-lock.

14. The traction battery pack of claim 1, wherein the housing assembly is dome-shaped, and further wherein the wall is part of an enclosure tray of the enclosure assembly.

15. The traction battery pack of claim 1, comprising a plurality of battery arrays housed inside the enclosure assembly.

16. A traction battery pack flow control method, comprising:
receiving a first amount of flow at an inlet of a pressure equalization device, the first amount of flow from an interior of a battery pack;
restricting the first amount of flow to a second amount of flow that is less than the first amount of flow; and
permitting the second amount of flow to move through a outlet of the pressure equalization device.

17. The traction battery pack flow control method of claim 16, wherein outlet is covered by a membrane.

18. The traction battery pack flow control method of claim 16, wherein the restricting occurs by directing the flow through an opening in a flow restrictor.

19. The traction battery pack flow control method of claim 18, wherein the flow restrictor is sandwiched between an engagement section and an outer section of a housing assembly.
